(19) United States
(12) Patent Application Publication
(10) Pub. No.: US 2024/0420222 A1
(43) Pub. Date: Dec. 19, 2024

(54) INFORMATION PROCESSING DEVICE AND INFORMATION PROCESSING METHOD

(71) Applicant: TOYOTA JIDOSHA KABUSHIKI KAISHA, Toyota-shi (JP)

(72) Inventors: Daisuke TANIZAKI, Kariya-shi (JP); Koichi IWATSUKI, Kariya-shi (JP)

(73) Assignee: TOYOTA JIDOSHA KABUSHIKI KAISHA, Toyota-shi (JP)

(21) Appl. No.: 18/647,202

(22) Filed: Apr. 26, 2024

(30) Foreign Application Priority Data
Jun. 14, 2023 (JP) 2023-098037

(51) Int. Cl. G06Q 30/0601

(52) U.S. Cl. CPC G06Q 30/0639

(57) ABSTRACT

An information processing device that provides information to a user traveling in a vehicle. The information processing device includes a control unit that calculates a third time length including at least a first time length and a second time length. The first time length is a time required from the time the user starts selecting an item to order using the mobile ordering system of a first shop on a route to the destination of the user to the time the operation to order the item is completed. The second time length is a time required for the first shop to prepare the item after an order is accepted. The control unit also proposes to the user to start ordering with the first shop using the mobile ordering system by the time that is the third time length back from the estimated time of user's arrival at the first shop.

### CROSS-REFERENCE TO RELATED APPLICATION

This application claims priority to Japanese Patent Application No. 2023-098037filed on Jun. 14, 2023, incorporated herein by reference in its entirety.

### BACKGROUND

### 1. Technical Field The present disclosure relates to providing information to a user.

### 2. Description of Related Art

Many techniques are known for providing information to a user traveling in a vehicle. For example, in this regard, Japanese Unexamined Patent Application Publication No. 2020-201208 (JP 2020-201208 A) discloses, a service provision instruction control device that sets the details of service to be received from service providers located on a route to the destination of the user, selects a service provider shop based on the user's current position and the details of service, and sends the details of service to the selected shop.

### SUMMARY

It is an object of the present disclosure to shorten the waiting time of a user who orders an item.

One aspect of the present disclosure relates to an information processing device that provides information to a user traveling in a vehicle. The information processing device includes a control unit. The control unit is configured to calculate a third time length including at least a first time length and a second time length. The first time length is a time required from the time the user starts selecting an item to order in the mobile ordering system of a first shop located on a route to the destination of the user to the time an operation to order the item is completed. The second time length is a time required for the first shop to prepare the item after an order is accepted. The control unit is also configured to propose to the user to start ordering with the first shop using the mobile ordering system by the time that is the third time length back from the estimated time of user's arrival at the first shop.

Other aspects include a method executed by the device described above, a program that causes a computer to execute the method, or a computer-readable storage medium storing therein the program in a non-transitory manner.

According to the present disclosure, the waiting time of a user who orders an item can be shortened.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a conceptual diagram showing processing performed by an information processing device;

FIG. 2 is a diagram showing components included in a system that includes the information processing device according to an embodiment;

FIG. 3 is a flowchart showing processing performed by a control unit of the information processing device according to the embodiment; and

FIG. 4 is a flowchart showing order sending processing performed by the control unit of the information processing device according to the embodiment.

### DETAILED DESCRIPTION OF EMBODIMENTS

A system is known that sends an order from a user to a shop located on a user's travel route.

For example, consider a case in which a user riding in a traveling vehicle orders with a restaurant on a travel route. In this case, it is supposed that the system allows the user to select an item from the menu of a restaurant located on the travel route and sends an order for the item to the restaurant.

However, the ordered item may not be ready when the user arrives at the shop to which the order was sent. In other words, even though the user has arrived at the shop, the user may not be able to receive the ordered item immediately. For example, when the time the user started ordering is late or when the user spent much time to select an item to order, it can be difficult for the shop to prepare the item by the time the user arrives at the shop.

To avoid this situation, it is preferable to start ordering using mobile ordering at a time considering both the time required for the user to order and the time required for the shop to prepare the item.

In the case where the user is heading to a shop on the travel route, an information processing device according to the present disclosure determines a time that is back from the estimated time of user's arrival at the shop by the time length that includes the time length required for ordering using mobile ordering and the time length required for the shop to prepare the item after receiving the order. In addition, the information processing device solves this problem by proposing to the user to order using mobile ordering by the time determined as described above.

An information processing device according to one aspect of the present disclosure is an information processing device that provides information to a user traveling in a vehicle. The information processing device includes a control unit. The control unit is configured to calculate a third time length including at least a first time length and a second time length. The first time length is a time required from the time the user starts selecting an item to order in the mobile ordering system of a first shop located on a route to the destination of the user to the time the operation to order the item is completed. The second time length is a time required for the first shop to prepare the item after an order is accepted. The control unit is also configured to propose to the user to start ordering with the first shop using the mobile ordering system by the time that is the third time length back from the estimated time of user's arrival at the first shop.

The first time length is the length of time from the time when the user starts selecting an item to order with the first shop using the terminal etc. associated with the user to the time when the operation to order is completed.

The second time length is the length of time from the time when the first shop receives an order from the user to the time when the preparation of the ordered item is completed.

The control unit proposes to the user to order using mobile ordering at a time before the user arrives at the first shop and during which the first time length and the second time length can be secured. This configuration allows the ordered item to be prepared at the shop before the user arrives at the first shop, making it possible to shorten the user's waiting time to receive the item.

The control unit may determine the first time length based on at least one of the number of occupants in the vehicle in which the user is riding, times of day during which the user makes the order, and whether the user has a coupon usable for the order.

This configuration allows the information processing device according to one aspect of the present disclosure to determine the first time length more accurately.

In addition, the control unit may send the order for the selected item to the first shop when a time arrives that is later than the time when the user completes the ordering operation and that is the second time length back from the estimated time of the user's arrival at the first shop.

For example, when the order is completed sooner than expected, the preparation of the item may be completed long before the user arrives and, in this case, a freshly prepared item cannot be provided. To prevent this, the information processing device may adjust the order sending time based on the second time length.

An information processing method according to one aspect of the present disclosure is an information processing method that provides information to a user traveling in a vehicle. The information processing method includes a step for calculating and a step for proposing. The step for calculating includes calculating a third time length including at least a first time length and a second time length. The first time length is a time required from the time the user starts selecting an item to order using the mobile ordering system of a first shop located on a route to the destination of the user to the time the operation to order the item is completed. The second time length is a time required for the first shop to prepare the item after an order is accepted. The step for proposing includes proposing to the user to start ordering with the first shop using the mobile ordering system by the time that is the third time length back from the estimated time of user's arrival at the first shop.

A specific embodiment of the present disclosure will be described below with reference to the drawings. Unless otherwise described, the hardware configuration, module configuration, functional configuration, etc. described in the embodiment are not intended to limit the technical scope of the disclosure.

### Embodiment

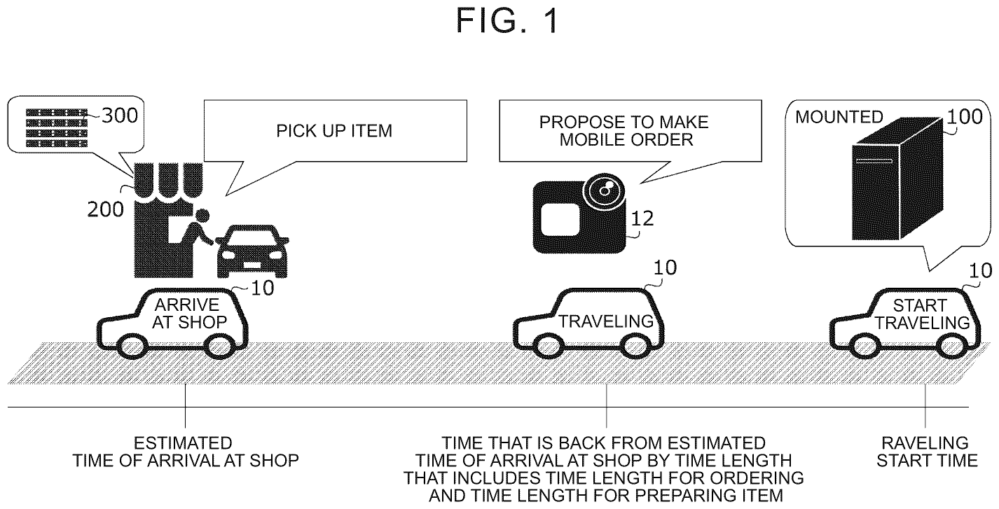

An overview of processing performed by the information processing device according to the embodiment will be described with reference to FIG. 1. FIG. 1 is a conceptual diagram showing processing performed by an information processing device 100. In this embodiment, the information processing device 100 provides information to a user via an in-vehicle terminal 12, and, at the same time, communicates wirelessly with a first shop server 300 installed in a first shop 200.

In this embodiment, a vehicle 10 includes the information processing device 100. When the vehicle 10 starts traveling, the information processing device 100 acquires the destination of the user of the vehicle 10 and the route to the destination. Then, the information processing device 100 identifies the first shop 200 (for example, a restaurant, etc.) that is located on the user's travel route and that provides various services supporting mobile ordering. A plurality of the first shops 200 may be identified here. In this case, from among the identified shops, the information processing device 100 may narrow down the shop (target shop) that the user is expected to use.

The information processing device 100 then calculates a first time length required by the user of the vehicle 10 to make a mobile order, and a second time length required by the first shop 200 to prepare the item after accepting the mobile order. The information processing device 100 also calculates the estimated arrival time at which the vehicle 10 is to arrive at the identified first shop 200.

The information processing device 100 then proposes to the user of the vehicle 10 to make a mobile order with the first shop 200 by a time back from the estimated time of arrival at the first shop 200 by the third time length that includes at least the first time length and the second time length. More specifically, the information processing device 100 may output the information to the in-vehicle terminal 12 of the vehicle 10 to propose to the user to order with the first shop 200 using the mobile ordering system.

Next, when the user of the vehicle 10 completes the order using mobile ordering, the information processing device 100 sends the details of the order to the first shop server 300. The first shop server 300 presents the information on the received order to the staff of the first shop 200. This makes it possible to start preparing the ordered item while the user of the vehicle 10 is heading to the first shop 200.

Then, the first shop 200 completes the preparation of the ordered item by the time the user of the vehicle 10 is estimated to arrive at the first shop 200. This allows the user of the vehicle 10 to receive the ordered item at the first shop 200 upon arrival at the first shop 200.

In this manner, the information processing device 100 proposes to the user to make an order using mobile ordering at a time considering both the time required for the user to order and the time required for the shop to prepare an item.

This allows the first shop 200 to receive an order with plenty of time and to complete the preparation of the item by the time the user arrives. Therefore, the information processing device 100 can shorten the waiting time of the user who orders an item.

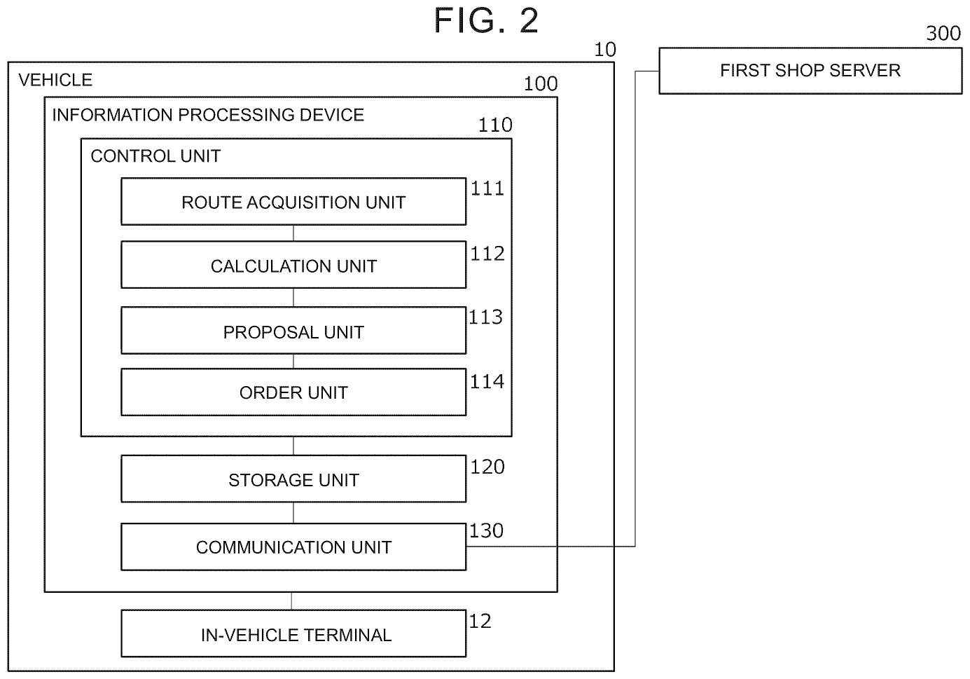

Next, the components of the system will be described in detail. FIG. 2 is a diagram showing the components of a system including the information processing device 100 according to the embodiment.

The information processing device 100 according to the embodiment includes a control unit 110, a storage unit 120, and a communication unit 130. The information processing device 100 is mounted on the vehicle 10.

The control unit 110 is implemented by a processor, such as a central processing unit (CPU) or a graphics processing unit (GPU), and a memory. The control unit 110 includes a route acquisition unit 111, a calculation unit 112, a proposal unit 113, and an order unit 114 as functional modules. These functional modules may be implemented when the control unit 110 executes the programs.

The route acquisition unit 111 acquires the information on the user's destination, the route information to the destination, etc. based on an input from the user via the in-vehicle terminal 12. The route acquisition unit 111 may communicate with an external server via the communication unit 130 to acquire the route information to the destination. The route acquisition unit 111 may also communicate with a terminal associated with the user (for example, a smartphone, etc.) to acquire the information on the user's destination from the terminal associated with the user.

The calculation unit 112 calculates the third time length including the first time length that is the time from the time when the user starts selecting an item to the time when the operation to order the item is completed and the second time length that is the time required from the time when the first shop server 300 accepts the order to the time when the item is prepared. That is, the calculation unit 112 calculates the time length required for the user to order an item using the mobile ordering system and the time length required for the shop from the time when the shop receives the order through the mobile ordering system to the time when the item is prepared and, then, calculates the third time length that includes both.

The proposal unit 113 proposes to the user to order with the first shop 200 using the mobile ordering system by the time that is the third time length back from the estimated time of user's arrival at the first shop 200. That is, the proposal unit 113 outputs the information proposing to the user to order using the mobile ordering system by the time that is back from the estimated time of user's arrival at the first shop 200 by a time length required for the user to order using the mobile ordering system and a time length required for the first shop 200 to prepare the ordered item.

The order unit 114 sends the order for the selected item to the first shop 200 when the user orders using the mobile ordering system and selects an item to order and then when the time arrives that is the second time length back from the estimated time of the user's arrival at the first shop 200. That is, the order unit 114 sends the order for the user-selected item to the first shop 200 when the time arrives that is before the estimated time of user's arrival at the first shop 200 by the time length required for the first shop 200 to prepare the ordered item.

The storage unit 120 includes a main storage device such as a RAM or ROM, and an auxiliary storage device such as an EPROM, a hard disk drive, and a removable medium. The auxiliary storage device stores an operating system (OS), various programs, various tables, etc. By executing the programs stored in the auxiliary storage device, the functions satisfying the predetermined purpose of each of the units of the control unit 110 are implemented. Note that a part or all of the functions may be implemented by hardware circuits such as ASICs or FPGAs.

The storage unit 120 stores data used or generated in the processing performed by the control unit 110. The storage unit 120 may also store the information such as map information and the information on shops that support mobile ordering.

The communication unit 130 is configured by a communication circuit that performs wireless communication. For example, the communication unit 130 may be a communication circuit that performs 4th generation (4G) based wireless communication or a communication circuit that performs 5th generation (5G) based wireless communication. Furthermore, the communication unit 130 may be a communication circuit that performs long term evolution (LTE) based wireless communication or may be a communication circuit that performs Low Power Wide Area (LPWA) based wireless communication. Furthermore, the communication unit 130 may be a communication circuit that performs Wi-Fi (registered trademark) based wireless communication.

Next, the devices other than the information processing device 100 will be described. The vehicle 10 is a passenger car, a truck, etc. The vehicle 10 has the in-vehicle terminal 12 for providing information to the user of the vehicle 10. The vehicle 10 sends information, such as the position information on the vehicle 10 or the speed information on the vehicle 10, to devices such as an external server in a predetermined cycle. Alternatively, the information processing device 100 may acquire information, such as the position information on the vehicle 10 or the speed information on the vehicle 10, from a unit, such as an ECU in the vehicle 10, in a predetermined cycle. The vehicle 10 may also has devices such as a speed sensor and a Global Positioning System (GPS) device.

The in-vehicle terminal 12 is a terminal that has the function to output various types of information, such as the information prompting mobile ordering, route guidance, or information on the state of the vehicle 10, to the user of the vehicle 10. The in-vehicle terminal 12 may be, for example, a car navigation device. Furthermore, the in-vehicle terminal 12 has the function to receive input from the user.

The first shop server 300 is a server device installed in the first shop 200 for accepting an order through mobile ordering. The first shop server 300 receives an order through mobile ordering from external terminals and provides the order to the staff of the first shop 200.

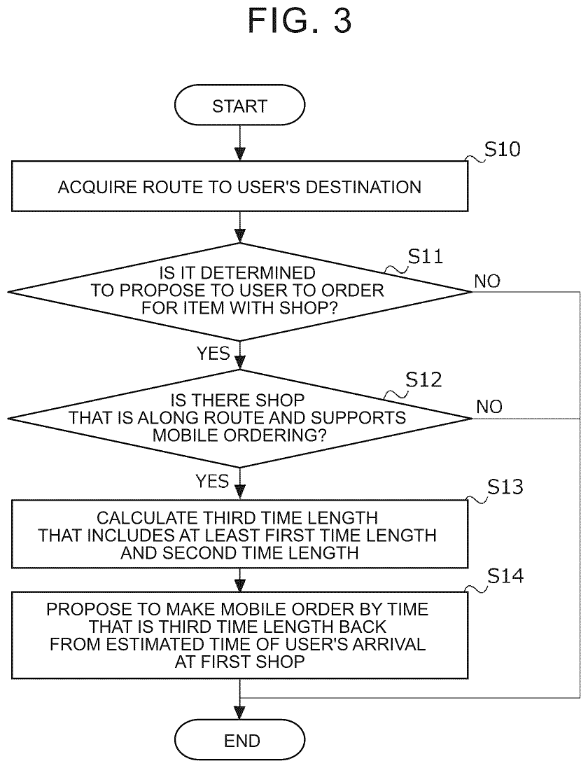

Next, the details of processing performed by the information processing device 100 will be described. FIG. 3 is a flowchart showing processing performed by the control unit 110 of the information processing device 100 according to the embodiment.

It is assumed that the vehicle 10, on which the information processing device 100 is mounted, has started traveling before the processing shown in FIG. 3 is performed. The information processing device 100 performs the following processing while the vehicle 10 is traveling. The state in which the vehicle 10 is traveling includes the state in which the vehicle 10 is stopped temporarily during a trip to the user's destination.

First, in step S10, the route acquisition unit 111 acquires the route to the user's destination. The route acquisition unit 111 acquires the destination entered by the user into the in-vehicle terminal 12 or into the terminal associated with the user and then contacts, for example, an external server to acquire the information on the route to the destination. When the in-vehicle terminal 12 has the navigation function, the route acquisition unit 111 may acquire the route information from the in-vehicle terminal 12. Next, in step S11, the calculation unit 112 determines whether to propose

to the user to order for an item with a shop. For example, when the current time of day is a busy hour for restaurants, the calculation unit 112 may determine that the user needs to order food and drink and then propose to the user to order for an item with a shop. The busy hour for restaurants is, for example, the lunch hour or the dinner hour. In this step, when the calculation unit 112 determines to propose to the user to order for an item with a shop, the determination result is affirmative.

When the determination result is affirmative in this step, the processing proceeds to step S12.

When the determination result is negative in this step, the processing ends.

Next, in step S12, the calculation unit 112 determines whether there is a shop that supports mobile ordering along the route acquired by the route acquisition unit 111. To make this determination, the calculation unit 112 may refer to a database (shop database) in which the information on shops is stored. The shop database may be stored in the information processing device 100 or may be provided by an external device. In this step, when the calculation unit 112 determines that there is a shop that supports mobile ordering along the route acquired by the route acquisition unit 111, the result of determination is affirmative. When the latitude and longitude of a location along the route acquired by the route acquisition unit 111 approximately match the latitude and longitude of a shop acquired from the shop database and supporting mobile ordering, the calculation unit 112 may determine that there is a shop that supports mobile ordering along the route acquired by the route acquisition unit 111.

When the result of determination is affirmative in this step, the processing proceeds to step S13.

When the result of determination is negative in this step, the processing ends.

Next, in step S13, the calculation unit 112 calculates the third time length that includes at least the first time length and the second time length. The calculation unit 112 calculates the time length that includes the time required for the user to complete the operation to order an item using the mobile ordering system and the time required for the first shop 200 to prepare the ordered item. That the user completes the operation to order an item using the mobile ordering system means that the user completes the selection of the item to be ordered in the mobile ordering system and performs the operation to order the item (for example, by pressing the order confirmation button).

Next, in step S14, the proposal unit 113 proposes to the user to order an item using mobile ordering by the time that is the third time length back from the estimated time of user's arrival at the first shop 200. More specifically, the proposal unit 113 outputs the information, which proposes to the user to order an item using mobile ordering, to the in-vehicle terminal 12 or to the terminal associated with the user by the time that is the third time length back from the estimated time of user's arrival at the first shop 200. For example, on the display of the in-vehicle terminal 12, the proposal unit 113 may display a QR code (registered trademark) representing the web page for accepting a mobile order with the first shop 200.

In this way, the information processing device 100 can propose to the user to order an item using mobile ordering at a time that allows the first shop 200 to prepare the item, ordered by the user, by the time the user arrives at the first shop 200.

Next, the details of processing in which the control unit 110 determines the first time length in step S13 will be described. In this embodiment, the control unit 110 determines the first time length based on at least one of the number of occupants in the vehicle 10, the times of day, and whether to use a coupon.

As described above, the control unit 110 of the information processing device 100 calculates the third time length including at least the first time length and the second time length, and proposes to the user to order an item using mobile ordering by the time that is the third time length back from the estimated time of user's arrival time at the first shop 200. At this time, the control unit 110 may determine the first time length as follows.

The calculation unit 112 can determine the first time length based on at least one of the number of occupants in the vehicle 10 in which the user is riding, the times of day during which the user is to order, and whether to use a coupon for ordering.

For example, the calculation unit 112 may set the first time length longer

as the number of occupants of the vehicle 10 in which the user is riding increases. This is because it is more likely that the number of items to be ordered by mobile ordering increases as the number of passengers in the vehicle 10 in which the user is riding increases, with the result that it takes more time to order. The calculation unit 112 may detect the number of occupants in the vehicle 10 in which the user is riding, using sensors in the seat belts in the vehicle 10. Alternatively, the calculation unit 112 may detect the number of occupants in the vehicle 10 in which the user is riding, using the in-vehicle camera or the weight sensor mounted on the vehicle 10.

In addition, the calculation unit 112 may set the first time length longer, for example, when the user orders during dinner hour than when the user orders during lunch hour. This is because it is more likely that more items are ordered via mobile ordering during dinner hour than during lunch hour with the result that ordering takes longer. The calculation unit 112 may calculate the user's ordering times of day using the timekeeping function built into the information processing device 100.

Similarly, the calculation unit 112 may set the first time length longer, for example, when the user has a coupon usable for mobile ordering than when the user does not have a coupon usable for mobile ordering. This is because it is more likely that the user is unable to make a quick decision when ordering when the user has a coupon usable for mobile ordering with the result that ordering take longer. The calculation unit 112 may acquire whether the user has a coupon usable for mobile ordering by referring to the information recorded on the terminal associated with the user.

In this way, the information processing device 100 can determine the first time length according to a situation expected when the user makes an order, based on at least one of the number of occupants in the vehicle 10, the time of day, and whether to use a coupon.

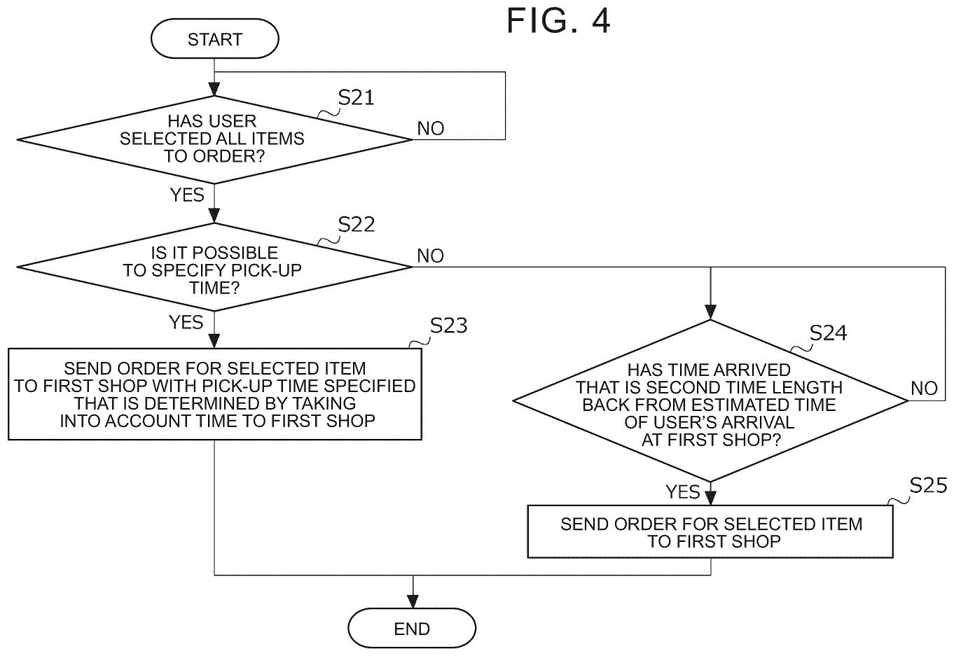

Next, the processing in which the control unit 110 sends an order for a selected item to the first shop 200 will be described. FIG. 4 is a flowchart showing order sending processing performed by the control unit 110 of the information processing device 100 according to the embodiment. The processing shown in FIG. 4 is performed after the processing shown in FIG. 3. When the user makes an order using the mobile ordering system, the information processing device 100 can perform processing to actually send the order to the first shop 200.

First, in step S21, the order unit 114 determines whether the user has selected all items to order. That the user has selected all items to order means that the user uses the mobile ordering system to complete the selection of all items to order. When the order unit 114 determines that the user has selected all items to order, the determination result of this step is affirmative.

When the determination result of this step is affirmative, the processing proceeds to step S22.

When the determination result of this step is negative, the processing proceeds again to step S21.

When the processing proceeds to step S22, the order unit 114 determines whether it is possible to specify a pick-up time for the ordered item at the first shop 200. When the order unit 114 determines that it is possible to specify a pick-up time for the ordered item at the first shop 200, the determination result of this step is affirmative.

When the determination result of this step is affirmative, the processing proceeds to step S23.

When the determination result of this step is negative, the processing proceeds to step S24.

When the processing proceeds to step S23, the order unit 114 sends the order for the selected item to the first shop server 300 with the pick-up time specified that is determined by taking into account the time required from the current position of the vehicle 10, in which the user is riding, to the first shop 200. More specifically, the order unit 114 may present the user with a time that is later than the current time by the time required from the current position of the vehicle 10 to the first shop 200 as an available pickup time and acquire a time specification from the user.

When the processing proceeds to step S24, the order unit 114 determines whether the time has arrived that is the second time length back from the estimated time of the user's arrival at the first shop 200. That is, the order unit 114 determines whether the time has arrived that is earlier from the estimated time of user's arrival time at the first shop 200 by the length of time required for the first shop 200 to prepare the ordered item. In this step, when the order unit 114 determines that the time has arrived that is the second time length back from the estimated time of user's arrival time at the first shop 200, the determination result of this step is affirmative.

When the determination result of this step is affirmative, the processing proceeds to step S25.

When the determination result of this step is negative, the processing proceeds again to step S24.

When the processing proceeds to step S25, the order unit 114 sends the order for the selected item to the first shop server 300. That is, the order unit 114 actually sends the user's order for the item that has been held until an appropriate time to the first shop server 300.

As described above, in the embodiment, the information processing device 100 lets the user start ordering at a time considering both the time required to order an item in the mobile ordering system and the time required for the first shop 200 to prepare the item. This can prevent the situation in which, though the user has arrived at the first shop 200, the user has to wait until the reception of the ordered item. In addition, the information processing device 100 sends the order to the shop at a time considering the time required for the first shop 200 to prepare the item. This can prevent the situation in which the item is prepared long before the user arrives, with the result that a freshly prepared item cannot be provided.

### (Modification)

The above embodiment is just an example, and the present disclosure can be modified as appropriate for implementation without departing from the spirit thereof.

For example, the processing and means described in the present disclosure can be implemented in any combination as long as there is no technical contradiction. Although an order is sent directly in the embodiment, there may be an intervening server device that accepts the order via mobile ordering.

The processing described as being performed by one device may be divided for execution by a plurality of devices. Conversely, the processing described as being performed by different devices may be performed by one device. In the computer system, the hardware configuration (server configuration) in which to implement each function can be flexibly changed.

The present disclosure can also be implemented by supplying to a computer a computer program that implements the functions described in the above embodiments and by causing one or more processors of the computer to read the program for execution. Such a computer program may be provided to the computer by a non-transitory computer-readable storage medium that can be connected to the system bus of the computer or may be provided to the computer via a network. The non-transitory computer-readable storage medium includes any type of disk, such as a magnetic disk (floppy (registered trademark) disk, hard disk drive (HDD), etc.) and an optical disc (CD-10 ROM, DVD disc, Blu-ray disc, etc.), and any type of medium suitable for storing electronic instructions such as a read only memory (ROM), a random access memory (RAM), an EPROM, an EEPROM, a magnetic card, a flash memory, and an optical card.

What is claimed is:

1. An information processing device that provides information to a user traveling in a vehicle, the information processing device comprising a control unit configured to:
calculate a third time length including at least a first time length and a second time length, the first time length being a time required from a time the user starts selecting an item to order in a mobile ordering system of a first shop located on a route to a destination of the user to a time an operation to order the item is completed, the second time length being a time required for the first shop to prepare the item after an order is accepted; and
propose to the user to start ordering with the first shop using the mobile ordering system by a time that is the third time length back from an estimated time of user's arrival at the first shop.

2. The information processing device according to claim 1, wherein the control unit is configured to determine the first time length based on at least one of the number of occupants in the vehicle in which the user is riding, times of day during which the user makes the order, and whether the user has a coupon usable for the order.

3. The information processing device according to claim 1, wherein the control unit is configured to send the order for the selected item to the first shop when a time arrives that is later than a time when the user completes the operation to order and that is the second time length back from the estimated time of the user's arrival at the first shop.

4. An information processing method for providing information to a user traveling in a vehicle, the information processing method comprising:
calculating a third time length including at least a first time length and a second time length, the first time length being a time required from a time the user starts selecting an item to order in a mobile ordering system of a first shop located on a route to a destination of the user to a time an operation to order the item is completed, the second time length being a time required for the first shop to prepare the item after an order is accepted; and
proposing to the user to start ordering with the first shop using the mobile ordering system by a time that is the third time length back from an estimated time of user's arrival at the first shop.
